(19) United States
(12) Patent Application Publication
(10) Pub. No.: US 2020/0114683 A1
(43) Pub. Date: Apr. 16, 2020

(54) BICYCLE WHEEL

(71) Applicant: Top Venturer International Limited., Taichung City (TW)

(72) Inventor: Yu-Shih CHEN, Taichung City (TW)

(21) Appl. No.: 16/158,265

(22) Filed: Oct. 11, 2018

(51) Int. Cl. B60B 21/06; B60B 27/02; B60B 1/04; B60B 1/00

(52) U.S. Cl. CPC B60B 21/062; B60B 27/023; B60Y 2200/13; B60B 1/003; B60B 1/042; B60B 1/041

(57) ABSTRACT

A bicycle wheel includes: a hub with a hub spindle and two ears disposed on the hub spindle, the hub spindle having an axial direction; a wheel frame having a connecting portion; and a plurality of spokes each having a connecting section and two support sections, wherein the connecting section of each of the spokes is inserted through the connecting portion and divided along the axial direction into a first side and a second side, one of the two support sections is connected to the first side and one of the ears, another of the two support sections is connected to the second side and another of the ears, and the two support sections are arranged along the axial direction.

### BACKGROUND

### Field of the Invention

The present invention relates to a bicycle, and more particularly to a bicycle wheel.

### Related Prior Art

Please refer to FIGS. 1 and 2, taking a bicycle wheel as an example, which essentially includes a hub 10, a wheel frame 20 and a plurality of spokes 30. The wheel frame 20 has a frame lip portion 21 for mounting a tire, a connecting portion 22 for connecting the spokes 30, and a frame bottom 23 between the frame lip portion 21 and the connecting portion 22. The connecting portion 22 has a first connecting wall 221 and a second connecting wall 222. As shown in the cross-sectional view of FIG. 1, each of the first connecting wall 221 and the second connecting wall 222 has one side connected to the frame bottom 23, and has another side connected to each other, such that the connecting portion 22 has a triangular cross section.

The hub 10 has a first hooking portion 11 and a second hooking portion 12. Some of the spokes 30 have two ends connected to the first connecting wall 221 and the second hooking portion 12, respectively, and the rest spokes 30 have two ends connected to the second connecting wall 222 and the first hooking portion 11, respectively.

In particular, one end of each of the spokes 30 connected to the connecting portion 22 has a first bending portion 31 and a second bending portion 32. Each of the first and second connecting walls 221, 222 is provided with a plurality of connecting holes 223, and the spokes 30 connected to the first connecting wall 221 and the second connecting wall 222 each have the first bending portion 31 inserted through one of the connecting holes 223, and then have the second bending portion 32 abutted against the first connecting wall 221 or the second connecting wall 222 to prevent the spokes 30 from disengaging from the respective connecting holes 223.

One end of each of the spokes 30 connected to the hub 10 has a third bending portion 33, and the first and second hooking portions 11, 12 are each provided with a plurality of hooking holes 101. The third bending portion 33 of each of the spokes 30 is inserted through one of the hooking holes 101, and the end of each of the spokes 30 has a locking bump 331 which has a diameter larger than the diameter of the hooking holes 101, so that, when inserted into the hooking holes 101, the spokes 30 will be blocked by the locking bumps 331 to prevent the spokes 30 from coining off the hooking holes 101.

In order to allow the user to adjust the tension of each of the spokes 30, each of the spokes 30 is further provided with a tension adjusting portion 34, and the user can adjust the length of the spokes 30 by rotating the tension adjusting portion 34, so that the tension between the wheel frame 20 and the hub 10 is further changed.

Since there is a bending angle A between the first bending portion 31 and the second bending portion 32, and between the second bending portion 32 and the third bending portion 33 of each of the spokes 30, when the tire contacts the ground and receives a force F1, the transmission direction of the force F1 is as shown in FIG. 1, the force F1 is transmitted from the tire to the wheel frame 20, and then is transmitted from the wheel frame 20 to each of the spokes 30. When the force F1 passes through each of the bending angles A, each of the bending angles A is not strong enough to withstand the supporting force F1, so that each of the spokes 30 is easily broken at a position of each of the bending angles A after a long time use. Besides, each of the tension adjusting portions 34 is provided on each of the spokes 30, the tension adjusting portion 34 is likely to be damaged when the force F1 passes through.

Further, the arrangement of the spokes 30 is generally as shown in FIG. 2, two spokes 30 are connected to the first connecting wall 221, and one spoke 30 connected the second connecting wall 222 (not shown) is located between the two spokes 30 connected to the first connecting wall 221. When in use, every point of the wheel frame 20 that contacts the ground, the force F1 from the tire is transmitted from the wheel frame 20 to the closest spokes 30, however, regardless of the position from which the wheel frame 20 contacts the ground, the force F1 from the ground must be transmitted to the nearest two or three of the spokes 30, and two of the three spokes 30 are located on the same side of the wheel frame 20, and another of the spokes 30 is located on the other side of the wheel frame 20, so that the force F1 transmitted by each of the spokes 30 is not uniform, and the wheel frame 20 is easily deformed or bent due to uneven force.

Referring to FIG. 3, in order to solve the problem that the structural strength of each of the spokes 30 is weak when the tension adjusting portions 34 are disposed on the spokes 30, there is a spoke 30 on the market where the tension adjusting portion 34 is located at one end of the spoke 30, and the tension adjusting portion 34 must be disposed on the frame bottom 23 of the wheel frame 20, as a result, the structural strength thereof is increased. However, when the tension of each of the spokes 30 needs to be adjusted, the user must remove the tire mounted on the frame lip portion 21 to expose each of the tension adjusting portions 34 located on the frame bottom 23, so that the user can rotate the respective tension adjusting portions 34 by a tool to adjust the tension of each of the spokes 30.

However, every time the user needs to adjust the tension, the tire must be removed, and it seems that the work of adjusting the tension is particularly troublesome.

In view of this, it is necessary to improve the following points:

1. Each of the spokes has too many bending angles, the structure of the spoke is fragile and easily damaged.

2. The tension adjusting portion is disposed at the center of the spoke, resulting in a fragile structure and the spoke is more likely to be damaged.

3. The arrangement of the spokes causes the force transmission to be uneven, making the wheel frame easy to deform or bend.

4. The tire must be removed when adjusting the tension, which makes the user very troublesome when adjusting the tension.

The present invention has arisen to mitigate and/or obviate the afore-described disadvantages.

### SUMMARY

A first objective of the present invention is to solve the problem of structural fragility caused by spoke bending.

A second objective of the present invention is to solve the problem that the tension adjusting portion is disposed at the center of the spoke, resulting in a fragile structure.

A third objective of the present invention is to solve the problem that the arrangement of the spokes leads to a loss of uneven force transmission.

A fourth objective of the present invention is to solve the trouble that the tension adjusting portion is provided at the frame bottom, and it is necessary to remove the tire when adjusting the tension.

To achieve the above objectives, a bicycle wheel in accordance with the present invention comprises:

a hub with a hub spindle and two ears disposed on the hub spindle, the hub spindle having an axial direction;

a wheel frame having a connecting portion; and

a plurality of spokes each having a connecting section and two support sections, wherein the connecting section of each of the spokes is inserted through the connecting portion and divided along the axial direction into a first side and a second side, one of the two support sections is connected to the first side and one of the ears, another of the two support sections is connected to the second side and another of the ears, and the two support sections are arranged along the axial direction.

Preferably, the wheel frame has a frame lip portion, and a frame bottom between the connecting portion and the frame lip portion, the connecting portion has two connecting walls extending from the frame bottom, one end of the two connecting walls is connected to the frame bottom, and the other ends of the connecting walls are connected to each other, and each of the spokes is inserted in the two connecting walls at a position close to the frame bottom.

Preferably, the connecting portion has two connecting walls, and a support wall disposed between the two connecting walls, each of the two connecting walls has two ends connected to the frame bottom and the support wall, respectively, and the connecting section of each of the spokes abuts against the support wall.

Preferably, each of the support sections is provided with a connecting hole, the connecting section has a through hole running through two ends of the connecting section, one fixing bolt is inserted into one of the connecting holes and the through hole, and another fixing bolt is inserted into another of the connecting holes and the through hole, so that the two support sections are assembled to the connecting section.

Preferably, the connecting portion has one connecting wall, the wheel frame includes a frame bottom, and each of the spokes is inserted through the connecting wall.

Preferably, the hub spindle has two opposite ends along the axial direction, the two ears are disposed at the two opposite ends of the hub spindle, each of the ears has a plurality of support ribs and a surrounding wall, each of the support ribs has two ends fixed to the hub spindle and the surrounding wall, respectively, the support ribs circumferentially surround the hub spindle, so that the surrounding wall surrounds the hub spindle along a circumferential direction of the hub spindle, one end of each of the two support sections is provided with an outer thread, and an adjusting member with an adjusting portion and a threaded portion, the threaded portion includes an inner thread, the threaded portion of each of the adjusting members is inserted through the surrounding wall of the ears, and the inner thread of each of the adjusting members is engaged with the outer thread of the two support sections.

Preferably, the two support sections are disposed at two ends of the connecting section, and located at the first side and the second side of the connecting section.

Preferably, the connecting section and the two support sections are integrally formed together.

Preferably, each of the spokes further has a collar sleeved on each of the spokes, and located between the spokes and the wheel frame.

Preferably, a bending portion is formed at each of two connection positions between the connecting section and the two support sections, and each of the spokes has two said collars disposed at the two bending portions.

Thereby, the support sections of the spokes of the present invention are arranged side by side along the axial direction of the hub, and are connected to the spokes disposed on two sides of the wheel frame, so that, when a force is applied to the wheel frame and transmitted to each of the spokes, the support section of each of the spokes can share the force transmission, in this way, the support section of each spoke can withstand more stress, and each spoke bends only at the positions where the support sections are connected with the connecting section, the bending portions are few in number, and the support sections of the spokes are arranged side by side in the axial direction, so that the spokes can be prevented from being damaged.

The present invention adjusts the tension by an adjusting member disposed at one end of the support sections, the adjusting member is fixed to one end of the support sections, and the ear of the hub has a surrounding wall surrounding the hub. The adjusting member is fixed on the surrounding wall, so that the user can adjust the adjusting member directly on the hub without disassembling the tire, and the adjusting member is disposed at one end of each of the support sections, the structure is surrounded by the surrounding wall, which in turn makes the support sections less susceptible to damage.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a cross sectional view showing that the conventional spokes are fixed to the hub;

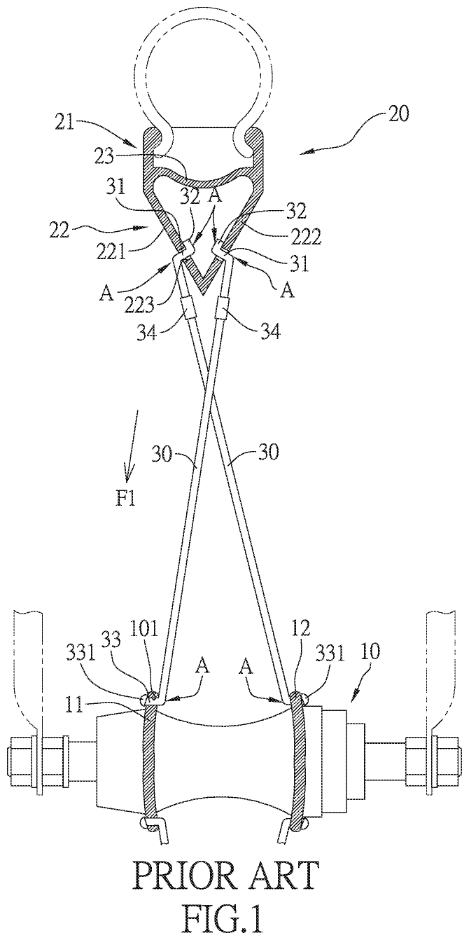

FIG. 2 shows that the conventional spokes are fixed to the hub and arranged in a staggered manner on the left and right sides;

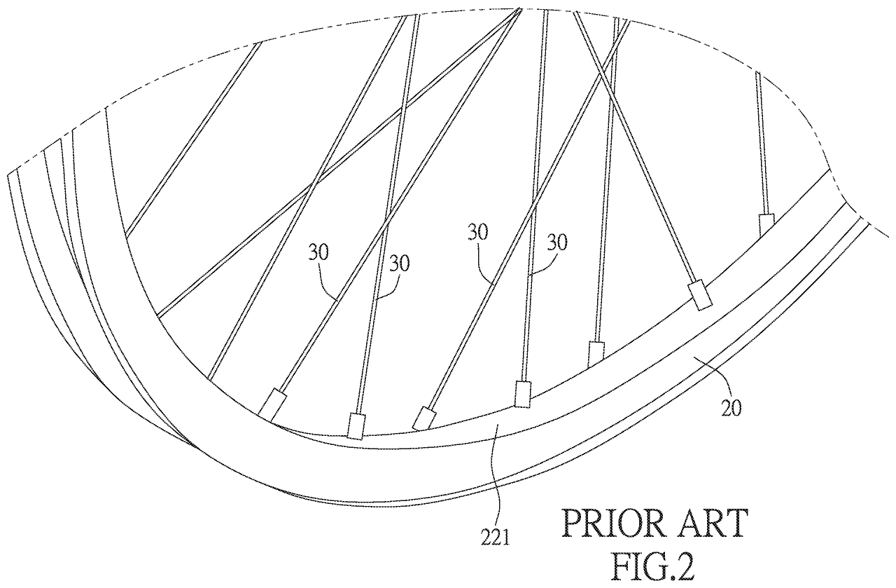

FIG. 3 is a structural view showing a conventional tension adjusting portion provided in a tire;

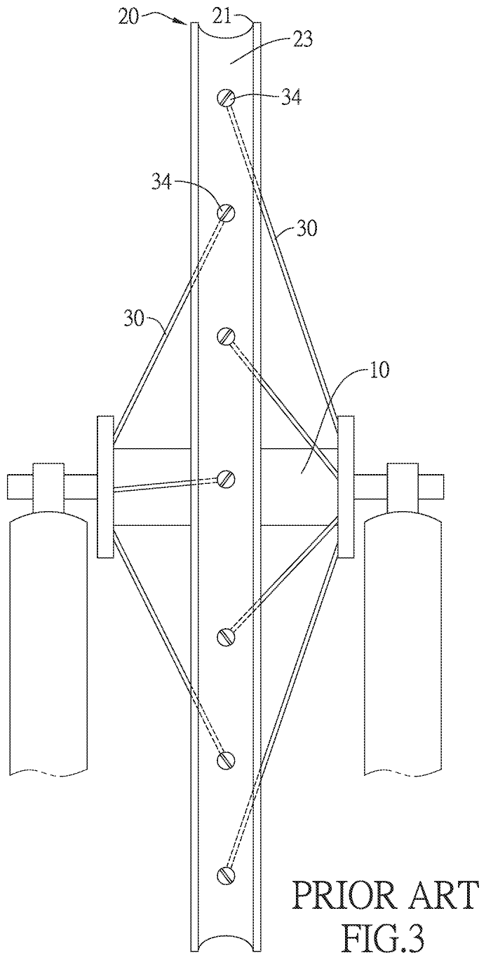

FIG. 4 is a perspective view of the first embodiment of the present invention, showing the spokes assembled on the hub and the wheel frame;

FIG. 5 is a cross-sectional view showing the first embodiment of the present invention;

FIG. 6 is a force transmission path of the wheel frame tilting force transmitted to the wheel frame via the tire and then transmitted from the wheel frame to the spoke in the first embodiment of the present invention;

FIG. 7A is a cross-sectional view of a second embodiment of the present invention;

FIG. 7B is an enlarged cross-sectional view of the second embodiment of the present invention showing the wheel frame and the spoke;

FIG. 8A is a cross-sectional view showing the third embodiment of the present invention;

FIG. 8B is an enlarged cross-sectional view showing the wheel frame and the spoke in the third embodiment of the present invention;

FIG. 9 is a force transmission path of the wheel frame tilting force transmitted to the wheel frame via the tire and then transmitted from the wheel frame to the spoke in the third embodiment of the present invention;

FIG. 10A is a cross-sectional view showing the fourth embodiment of the present invention;

FIG. 10B is an enlarged cross-sectional view showing the wheel frame and the spoke in the fourth embodiment of the present invention;

FIG. 11A is a cross-sectional view showing the fifth embodiment of the present invention;

FIG. 11B is an enlarged cross-sectional view showing the wheel frame and the spoke in the fifth embodiment of the present invention;

FIG. 12 is an enlarged exploded view of the wheel frame, the spokes and the fixing bolts in the sixth embodiment of the present invention;

FIG. 13 is a partially magnified cross-sectional view showing the wheel frame, the spokes and the fixing bolts in the sixth embodiment of the present invention; and

FIG. 14 is a cross-sectional view showing the seventh embodiment of the present invention.

### DETAILED DESCRIPTION

The present invention will be clearer from the following description when viewed together with the accompanying drawings, which show, for purpose of illustrations only, the preferred embodiment in accordance with the present invention.

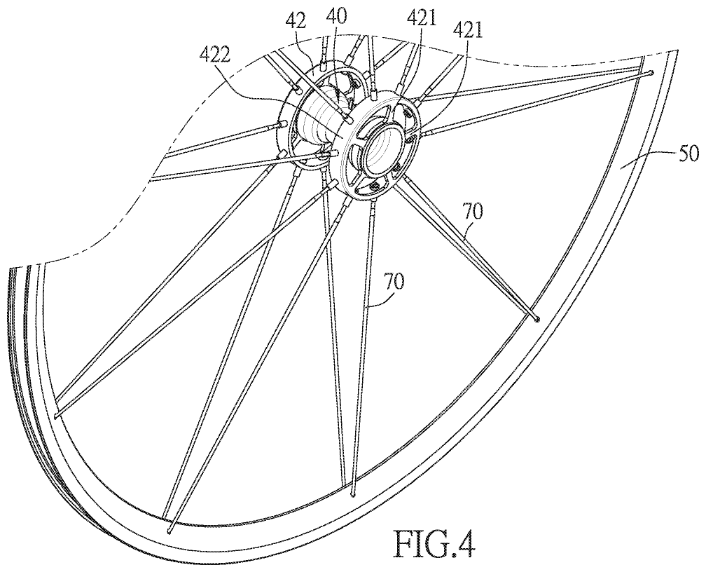

Referring to FIGS. 4-6, a bicycle wheel in accordance with a first embodiment of the present invention comprises: a hub 40, a wheel frame 50, and a plurality of spokes 70.

The hub 40 includes a hub spindle 41 and two ears 42 disposed on the hub spindle 41. The hub spindle 41 has an axial direction X and two opposite ends along the axial direction X. The two ears 42 are disposed at the two opposite ends of the hub spindle 41, and each of the ears 42 has a plurality of support ribs 421 and a surrounding wall 422. Each of the support ribs 421 has two ends fixed to the hub spindle 41 and the surrounding wall 422, respectively. The support ribs 421 circumferentially surround the hub spindle 41, so that the surrounding wall 422 surrounds the hub spindle 41 along the circumferential direction of the hub spindle 41.

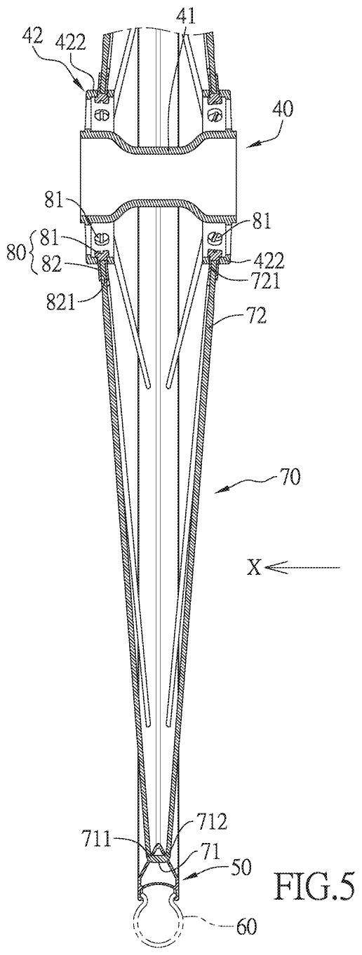

The wheel frame 50 has a connecting portion 51, a frame lip portion 52, and a frame bottom 53 between the connecting portion 51 and the frame lip portion 52. The connecting portion 51 has two connecting walls 511 extending from the frame bottom 53. One end of the two connecting walls 511 is connected to the frame bottom 53, and the other ends of the connecting walls 511 are connected to each other, so the frame bottom 53 generally has a triangular cross section as shown in FIG. 5, and the frame lip portion 52 is provided for mounting of a tire 60.

Each of the spokes 70 has a connecting section 71 and two support sections 72. The connecting section 71 is inserted through the two connecting walls 511 and provided with a first side 711 and a second side 712 along the axial direction X. It is to be noted that the first and second sides 711, 712 can be interpreted as two opposite ends of the connecting section 711, but are not limited to the ends, as long as the positions near the opposite ends of the connecting section 71 are considered as the first side 711 and the second side 712. One of the two support sections 72 is connected to the first side 711 and one of the ears 42, and the other of the two support sections 72 is connected to the second side 712 and the other of the ears 42, and the two support sections 72 are arranged along the axial direction X.

In the first embodiment, the two support sections 72 have one end connected to the first side 711 and the second side 712 of the connecting section 71, respectively, so that each of the spokes 70 is substantially U-shaped, and in this embodiment, the connecting section 71 and the two support sections 72 are integrally formed together.

Referring to FIG. 5, another end of each of the support sections 72 connected to the connecting section 71 is provided with an outer thread 721, and an adjusting member 80 with an adjusting portion 81 and a threaded portion 82. The threaded portion 82 is provided for the user to rotate, and includes an inner thread 821. The threaded portion 82 of the adjusting member 80 is inserted through the surrounding wall 422 of the ears 42, and the inner thread 821 of the threaded portion 82 is engaged with the outer thread 721. The user rotates the adjusting portion 81 to rotate the adjusting member 80. With the inner thread 821 engaging with the outer thread 721, the length of the support section 72 of the spokes 70 can be micro adjusted, which, in turn, changes the tension between the wheel frame 50 and the hub 40. Since the position at which the tension of the support sections 72 is adjusted is located on the hub 40, the support sections 72 can extend straight without a bend, thereby making the overall structure more stable.

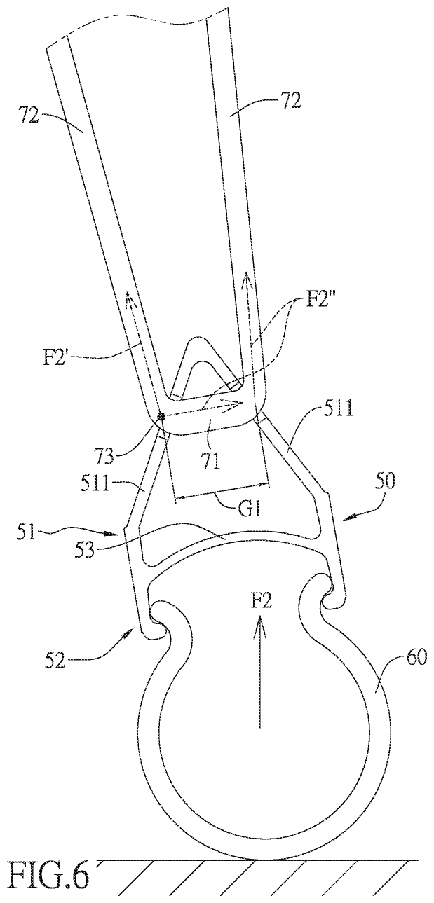

Referring to FIG. 6, a bending portion 73 is formed at each of the connection positions between the connecting section 71 and the two support sections 72. When the wheel frame 50 contacts the ground in an inclined manner, a force F2 from the ground is transmitted from the tire 60 to the wheel frame 50. Since the wheel frame 50 is inclined, the force F2 first passes through one of the bending portions 73. After passing through the bending portion 73, the force F2 is divided into a first component of force F2′ and a second component of force F2″ by one of the support sections 72 and the connecting section 71. The first component of force F2′ is transmitted along one of the support sections 72, and the second component of force F2″ is transmitted along the connecting section 71 to the other of the support sections 72, so that the force F2 is dispersed to one of the support sections 72 through the first component of force F2′, and is further dispersed to the connecting section 71 and the other of the support sections 72 via the second component of force F2″.

The connecting section 71 is connected to the two support sections 72, so that the force F2 can be dispersed along the first component of force F2′ and the second component of force F2″ to the two support sections 72 after passing through one of the bending portions 73, and thus the force F2 can be supported by the two support sections 72.

More preferably, since the two support sections 72 are arranged along the axial direction X, when the force F2 is transmitted to the hub 40 via the first component of force F2′ and the second component of force F2″, the force F2 is evenly transmitted along the axial direction X to the two ears 42 of the hub 40, so that the connecting portion 51 of the wheel frame 50 is evenly pressed, thereby preventing the wheel frame 50 from being bent or deformed.

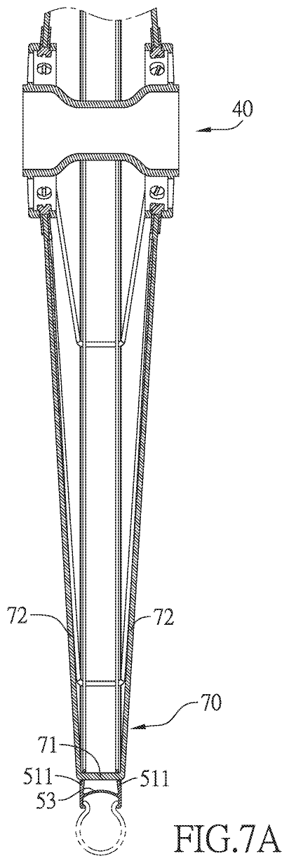

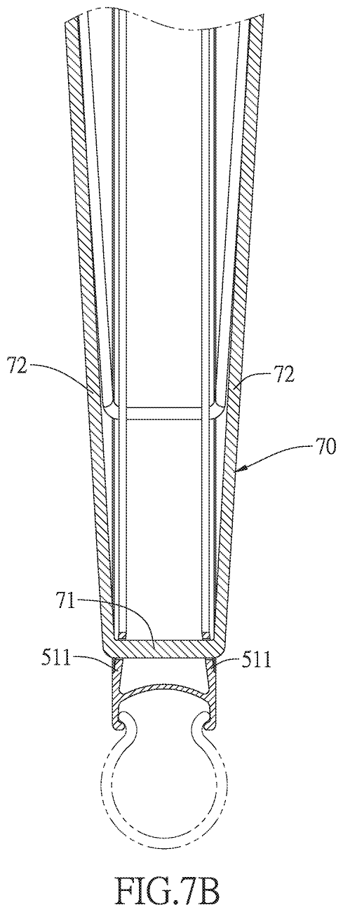

Referring to FIGS. 7A and 7B, in a second embodiment of the present invention, one end of the two connecting walls 511 is connected to the frame bottom 53, and the other ends of the two connecting walls 511 are not connected to each other. The connecting section 71 of each of the spokes 70 is inserted through the two connecting walls 511, and the two support sections 72 of each of the spokes 70 are respectively connected to the connecting section 71 and the hub 40.

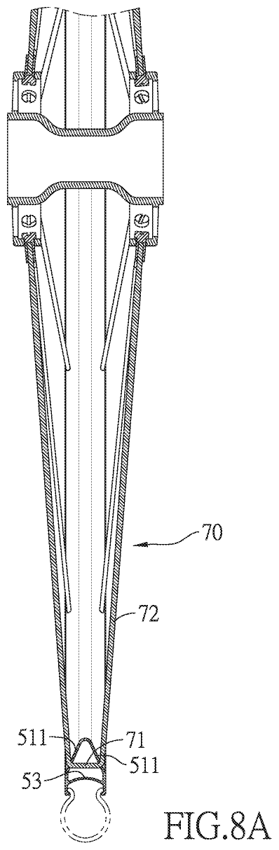

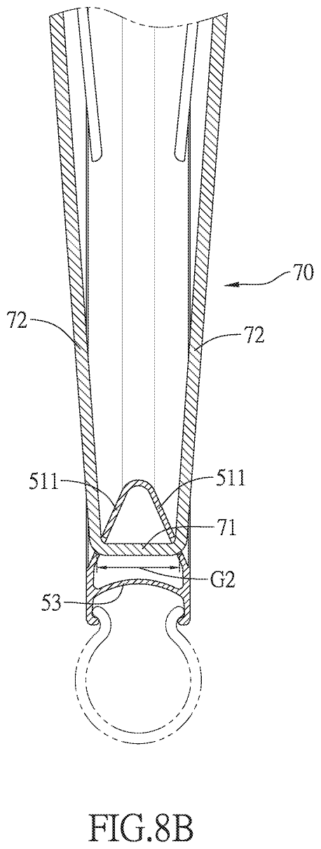

Referring to FIG. 6, in the first embodiment, each of the spokes 70 is inserted in the two connecting walls 511 at a position away from the frame bottom 53, so that the connecting section 71 of each of the spokes 70 in this embodiment has a first length G1. Please refer to FIGS. 8A and 8B, in a third embodiment of the present invention, each of the spokes 70 is inserted in the two connecting walls 511 at a position close to the frame bottom 53, so that the connecting section 71 of each of the spokes 70 in this embodiment has a second length G2 which is greater than the first length G1.

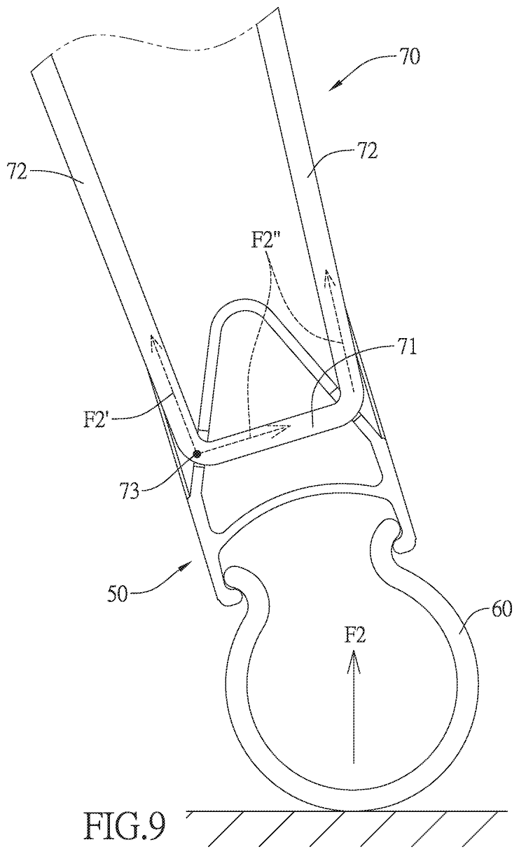

Referring to FIG. 9, in the third embodiment of the present invention, when the wheel frame 50 is inclined, the force F2 is transmitted from the tire 60 to the wheel frame 50, and then transmitted from the wheel frame 50 to one of the bending portions 73, so that the force F2 is dispersed to one of the support sections 72 through the first component of force F2′, and is further dispersed to the connecting section 71 and the other of the support sections 72 via the second component of force F2″. Since the connecting section 71 is long, more of the force F2 can be transmitted to the connecting section 71 along the second component of force F2″, thereby allowing the force F2 to be more evenly distributed to the two support sections 72 of each of the spokes 70 to make each of the spokes 70 stronger and less susceptible to damage.

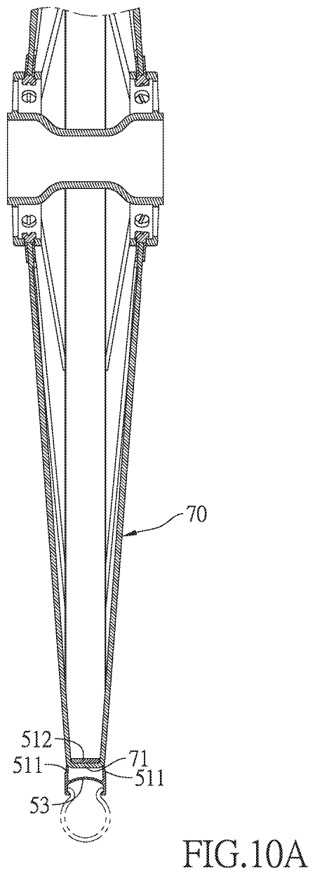

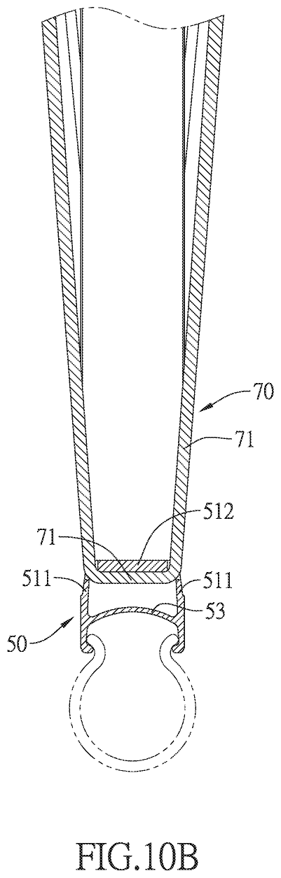

Referring to FIGS. 10A and 10B, in a fourth embodiment of the present invention, a support wall 512 is disposed between the two connecting walls 511, and each of the two connecting walls 511 has two ends connected to the frame bottom 53 and the support wall 512, respectively. The connecting section 71 abuts against the support wall 512. The cross section of the wheel frame 50 is as shown in FIG. 10, so that the support wall 512 supports the connecting section 71 of each of the spokes 70 to achieve the effect of preventing damage to the spokes 70.

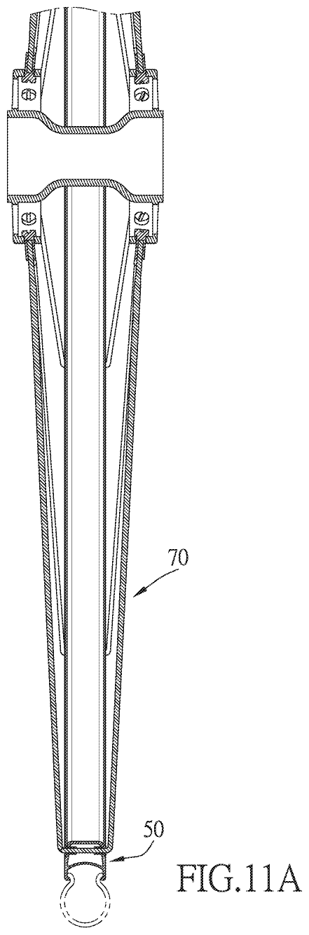

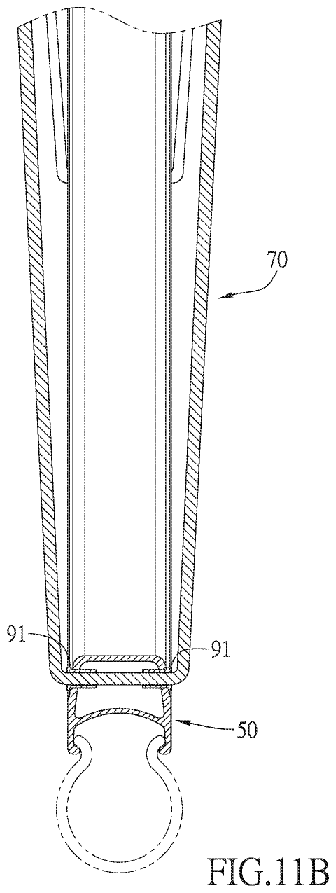

Referring to FIGS. 11A and 11B, in a fifth embodiment of the present invention, each of the spokes 70 further has two collars 91 sleeved on the spoke 70, and located between the spoke 70 and the wheel frame 50 respectively, and the collars 91 are pressed against to prevent the spokes 70 from shaking.

Preferably, the two collars 91 are sleeved at the bending portions 73 of the spoke 70, respectively to improve the strength of the bending portions 73 of each of the spokes 70, thereby making the spokes 70 stronger.

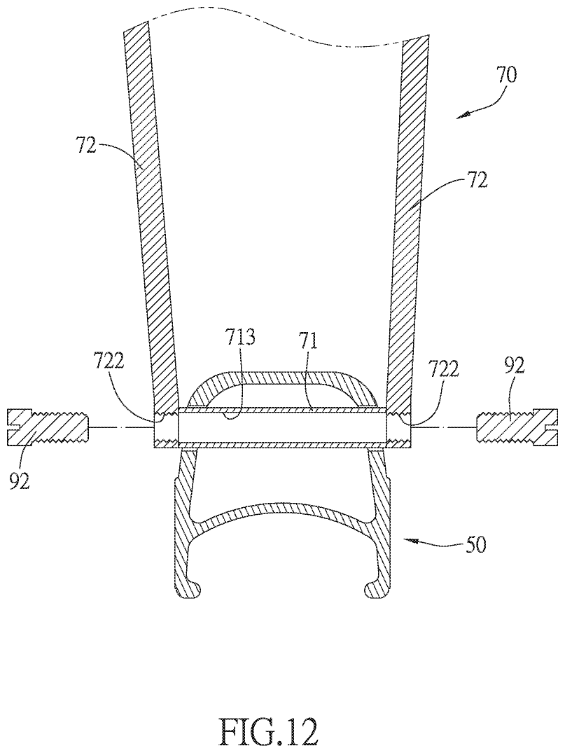

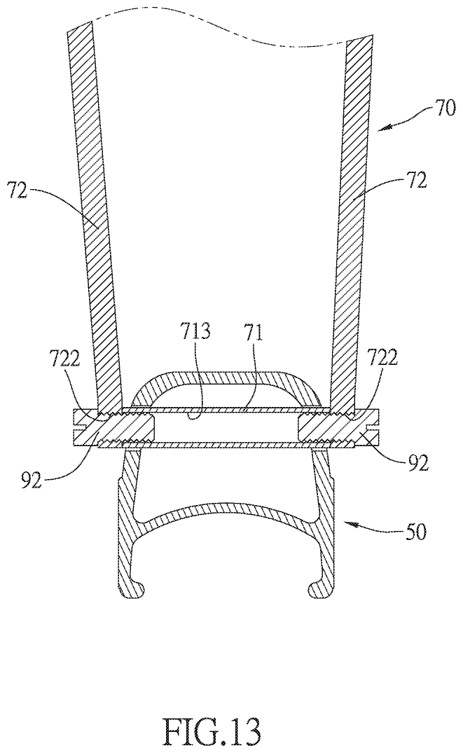

Referring to FIGS. 12 and 13, in a sixth embodiment of the present invention, the connecting section 71 and the two support sections 72 are not integrally formed, and another end of each of the support sections 72 that is not connected to the hub 40 is provided with a connecting hole 722. The connecting section 71 has a through hole 713 running through the two ends of the connecting section 71. One fixing bolt 92 is inserted into one of the connecting holes 722 and the through hole 713, and another fixing bolt 92 is inserted into the other of the connecting holes 722 and the through hole 713, so that the two support sections 72 are assembled to the connecting section 71, and the detachable connecting section 71 and support sections 72 make the disassembly and assembly of the spokes 70 to the wheel frame 50 easier.

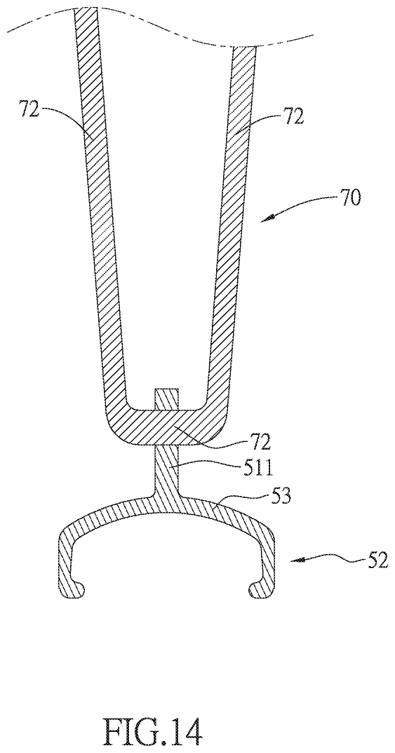

Referring to FIG. 14, the connecting portion 51 only has one connecting wall 511 which extends from the frame bottom 53, and the spoke 70 is inserted through the connecting wall 511 to make the support section 72 of the spoke 70 abut against the connecting wall 511. Since the wheel frame 50 only has one connecting wall 511, it has the advantage of being light in weight.

While we have shown and described various embodiments in accordance with the present invention, it is clear to those skilled in the art that further embodiments may be made without departing from the scope of the present invention.

What is claimed is:

1. A bicycle wheel comprising:
a hub with a hub spindle and two ears disposed on the hub spindle, the hub spindle having an axial direction;
a wheel frame having a connecting portion; and
a plurality of spokes each having a connecting section and two support sections, wherein the connecting section of each of the spokes is inserted through the connecting portion and provided with a first side and an opposite second side along the axial direction, one of the two support sections is connected to the first side and one of the ears, another of the two support sections is connected to the second side and another of the ears, and the two support sections are arranged along the axial direction.

2. The bicycle wheel as claimed in claim 1, wherein the wheel frame has a frame lip portion, and a frame bottom between the connecting portion and the frame lip portion, the connecting portion has two connecting walls extending from the frame bottom, one end of the two connecting walls is connected to the frame bottom, and the other ends of the connecting walls are connected to each other, each of the spokes is inserted in the two connecting walls, and a distance between the connecting section and the frame bottom is greater than a distance between connecting section and a position where the connecting walls are connected to each other.

3. The bicycle wheel as claimed in claim 1, wherein the connecting portion has two connecting walls, and a support wall disposed between the two connecting walls, each of the two connecting walls has two ends connected to the frame bottom and the support wall, respectively, and the connecting section of each of the spokes abuts against the support wall.

4. The bicycle wheel as claimed in claim 1, wherein each of the support sections is provided with a connecting hole, the connecting section has a through hole running through two ends of the connecting section, one fixing bolt is inserted into one of the connecting holes and the through hole, and another fixing bolt is inserted into another of the connecting holes and the through hole, so that the two support sections are assembled to the connecting section.

5. The bicycle wheel as claimed in claim 1, wherein the connecting portion has one connecting wall, the wheel frame includes a frame bottom connected to the connecting wall, and each of the spokes is inserted through the connecting wall.

6. The bicycle wheel as claimed in claim 1, wherein the hub spindle has two opposite ends along the axial direction, the two ears are disposed at the two opposite ends of the hub spindle, each of the ears has a plurality of support ribs and a surrounding wall, each of the support ribs has two ends fixed to the hub spindle and the surrounding wall, respectively, the support ribs circumferentially surround the hub spindle, so that the surrounding wall surrounds the hub spindle along a circumferential direction of the hub spindle, one end of each of the two support sections is provided with an outer thread, and an adjusting member with an adjusting portion and a threaded portion, the threaded portion includes an inner thread, the threaded portion of each of the adjusting members is inserted through the surrounding wall of the ears, and the inner thread of each of the adjusting members is engaged with the outer thread of the two support sections.

7. The bicycle wheel as claimed in claim 1, wherein the two support sections are disposed at two ends of the connecting section, and located at one end of the first side and one end of the second side of the connecting section, respectively.

8. The bicycle wheel as claimed in claim 1, wherein the connecting section and the two support sections are integrally formed together.

9. The bicycle wheel as claimed in claim 1, wherein each of the spokes further has a collar sleeved on each of the spokes, and located between the spokes and the wheel frame.

10. The bicycle wheel as claimed in claim 9, wherein a bending portion is formed at each of two connection positions between the connecting section and the two support sections, and each of the spokes has two said collars disposed at the two bending portions.
